(19) United States
(12) Patent Application Publication
(10) Pub. No.: US 2014/0159537 A1
(43) Pub. Date: Jun. 12, 2014

(54) ASYNCHRONOUS MACHINE

(71) Applicants: Thomas Hildinger, Heidenheim (DE); Stefan Veser, Treffelhausen (DE); Philipp Eilebrechet, Heidenheim (DE); Ludger Koedding, Heidenheim (DE)

(72) Inventors: Thomas Hildinger, Heidenheim (DE); Stefan Veser, Treffelhausen (DE); Philipp Eilebrechet, Heidenheim (DE); Ludger Koedding, Heidenheim (DE)

(73) Assignee: Voith Patent Gmbh, Heidenheim (DE)

(21) Appl. No.: 14/127,427

(22) PCT Filed: Jun. 13, 2012
(86) PCT No.: PCT/EP2012/002487

§ 371 Date: Feb. 20, 2014

(30) Foreign Application Priority Data
Jun. 14, 2011 (DE) 10 2011 106 480.3

(51) Int. Cl. H02K 3/487; H02K 3/40

(52) U.S. Cl. CPC H02K 3/487; H02K 3/40
USPC 310/214

(57) ABSTRACT

The invention concerns an asynchronous machine having a slip-ring rotor for use with a variable rotational speed, with
a rotor,
a rotor body, having grooves mounted radially into the rotor body,
winding elements of the rotor, from which respectively at least one element runs axially through each of the grooves,
locking elements, which co-operate in a form fit manner with the rotor body and close the grooves radially and outwardly,
a high voltage insulation with outer corona protection around each of the winding elements.

The invention is characterised in

that between the outer corona protection of the winding element and at least one neighbouring wall of the groove in peripheral direction electrically conducting connecting means are arranged for releasable connection of the winding element with the rotor body.

The invention concerns an asynchronous machine having a slip-ring rotor for use with variable rotational speeds according to the type described more in detail in the preamble of claim 1. Moreover, the invention concerns a machine assembly for a hydroelectric power plant with such an asynchronous machine.

Asynchronous machines are known from the general state of the art. Typically, asynchronous machines are used as motors or generators. They consist of a rotor with windings, which is contacted via slip rings. In order to anchor the windings into the runner or the rotor of the asynchronous machine securely and reliably it is generally known and usual to place the windings in grooves in the rotor of the asynchronous machine and to glue them in that position. Typically, the operation consists in dipping the complete rotor into a suitable bath for instance of epoxy resin so that the rotor is glued as a whole.

This method for fixing the winding elements in the region of the rotor of an asynchronous machine is proven and reliable. Indeed, the construction is limited to a certain construction size of the asynchronous machine. The problematic is then that asynchronous machines, in particular double-fed asynchronous machines, are realised more and more with an increasing construction size, and are provided by way of example for use in hydroelectric power plants as a generator or a motor generator in case of a pumped-storage power plant. Such machines, which are designed typically in a power category of more than 30 MVA, hence exhibit a very large construction size. The rotor diameters lie typically in the order of magnitude of 3 to 8 m, so that a complete soaking of the rotor by way of example cannot be performed or only at considerable expense in a vacuum with a epoxy resin. Even the subsequent hardening, by way of example in an autoclave, requires extremely large assemblies and is hence highly wasteful and costly. This is economically not possible with the usual quantity of such pieces.

A further problem of such a construction, even it could glue the winding elements in the rotor with reasonable costs by soaking the rotor, is that the ease of maintenance plays a decisive role with such machines. Due to the total costs and the necessary lifetime of such a machine until amortisation, the change of individual winding elements must be possible, without damaging the rotor or the rotor body of the machine. This is not possible with fully glued constructions.

A further problem is that the machines are driven at very high rotational speeds. The centrifugal forces exerted on the winding elements which are correspondingly big and strong due to this size, are hence quite significant. Glue on its own cannot oppose said centrifugal forces. It is thus common in the state of the art to provide barrier elements radially and outwardly in the region of the grooves which accommodate the winding elements, barrier elements sealing the grooves radially and outwardly and meshing with the rotor body in a form locking manner. The winding elements may well be protected against centrifugal forces with such measures, the problematic is still that the winding elements, which typically have an insulation and an corona protection around the insulation, must be in contact during regular exploitation with the walls of the grooves in which they are accommodated, to realise a reliable electric conduction between the outer corona protection and the rotor body. The consequence of an interruption of the contact and an air gap is spark erosion produced by flashing discharges, which destroy the insulation and the outer corona protection of the winding element and hence damage the rotor.

The object of the present invention is then to provide an asynchronous machine, in which the winding elements are fixed in the region of the rotor in such a way that a reliable bonding of the outer corona protection of the insulation of the winding element with the material of the rotor body even in the presence of fluctuating thermal and/or mechanical stress is guaranteed reliably, and simple interchangeability is ensured without damaging the rotor although the winding elements are fixed solidly in the region of the rotor.

According to the invention, said object is satisfied by the features mentioned in the characterising part of claim 1. Additional advantageous embodiments of the asynchronous machine according to the invention are indicated in the depending-claims. Moreover, a machine assembly with such an asynchronous machine is indicated in claim 14.

With the asynchronous machine according to the invention, it is also provided to hold the rotor winding elements in their grooves in radial direction by barrier elements, as well as in the state of the art. It is moreover provided according to the invention that between the outer corona protection of the winding elements and at least one neighbouring wall of the groove around the periphery of the winding element electrically conducting connecting means are arranged for releasable connection of the winding element with the rotor body. The conducting connecting means, which enable releasable connection of the winding element with the groove at least along the periphery, always guarantee on the one hand possible disassembly of the winding element from the groove and can ensure on the other hand through the secure and reliable connection an electrical conductivity between the insulation and the outer corona protection of the winding element and the wall of the groove. Spark discharges and the resulting spark erosion, which could damage the insulation of the winding element, can hence be prevented securely and reliably. By electrically conducting connection in the sense of the present invention is meant here any connection which shows a conductivity which is at least in the order of magnitude of the conductivity of the outer corona protection of the winding elements. An electrically conducting material in the sense of the invention can oppose the electric current a specific electric surface resistance in the order of magnitude of approx. 200-50,000 Q/square.

It is provided in an advantageous further embodiment of the structure of the asynchronous machine according to the invention that the connecting means include an electrically conducting layer and a pasty substance. The electrically conducting layer can for instance be a film or in particular an electrically conducting paper. Said electrically conducting layer guarantees together with a pasty substance, for instance a putty, a secure and reliable fastening of the winding elements in the grooves. By way of example, the winding element can be coated with the pasty substance and wrapped with the conductive layer. The electrically conducting layer and the pasty substance, which must be electrically conductive in the described example as well, provides the secure and reliable connection on the one hand, there is on the other hand between the conductive layer and, in the above example of the wall of the groove, no material bonding or no adherence. It is thus possible to release the connection.

In an advantageous further embodiment thereof, the pasty substance is hence designed in such a way that the pasty substance increases its volume when hardening. If said structure is then inserted into the grooves, the pasty substance wells up accordingly and thus provides a secure bond with the grooves in a form fit manner.

The pasty substance can for instance be designed on the basis of an epoxide resin.

According to an additional very favourable embodiment of this idea, it can more-over be provided that the pasty substance hardens elastically. It can also harden with a certain elasticity, for example when using silicon as a pasty substance. There can be a suitable balance in the presence of temperature-related fluctuations and/or mechanical fluctuations in the elongation of the winding element and the groove so that even under these conditions a secure and reliable electrically conducting connection can be established between the outer corona protection of the winding element and the walls of the groove.

In a further very favourable embodiment it can be moreover provided that the layer is designed with at least one fold, whereas the pasty substance is arranged between at least two sections formed by the fold. With this structure, the choice of the pasty substance is much wider since said substance need not be designed electrically conductive any longer. Said substance is hence arranged between the sections of the layer which are formed by the fold, since said substance only comes in contact with the layer. The surfaces facing away from the pasty substance, of the individual sections of the layer, then come in contact with the insulated winding element on the one hand and the wall of the groove on the other hand. If the pasty substance increases its volume when hardening, it ensures reliable hold of the insulated winding element in the groove in the above described type. Since it is in contact with the wall of the groove as well as with the outer corona protection of the winding element only via the layer, the electrical conductivity on the one hand between the outer corona protection and the wall of the groove is guaranteed by the layer and both partners are not glued together on the other hand so that disassembly with respect to the above-described structure is further facilitated.

In a further very advantageous embodiment of the asynchronous machine according to the invention it can be provided in complement thereto or alternatively that the connecting means include wedges made of electrically conducting material. By such wedges, which preferably are incorporated in radial direction between the winding element and the neighbouring wall of the groove along the periphery, a mechanical security and a positive connection can also be established between the insulated winding element and the walls of the groove. If the material of the wedges is electrically conductive at least in the above-described sense the conductivity is besides guaranteed. It would be possible properly speaking and as a matter of principle to use corresponding materials for the wedges, which exhibit a slight elasticity so that the wedges can be released even in the presence of thermally-induced differences in elongation between the winding elements and the material of the rotor body and the wedges can still be held securely and reliably. In another configuration of the asynchronous machine according to the invention, the connection elements can also be designed as spring elements. Such spring elements, which for example can be realised by way of example as wave springs, hence have the decisive advantage that they provide a secure and reliable inter-locking of the winding element directly with the wall of the groove via the spring elements with the wall of the groove and preferably the side of the winding element which is opposed to the spring element. Spring elements which are mounted one-sided between the winding element and the neighbouring wall of the groove along the periphery, can provide a secure and reliable fastening, which is designed simultaneously to be electrically conductive and mechanically releasable.

A particularly preferred application for such an asynchronous machine, which can be designed in a preferred further embodiment as a double-fed asynchronous machine, lies hence in the use in a machine assembly for a hydroelectric power plant, having a water turbine or a pump turbine and the asynchronous machine, which is driven by the water turbine or the pump turbine or drives the pump turbine. In particular in such an application in a machine assembly for a hydroelectric power plant, which often exhibit a rotation axis of the asynchronous machine in the direction of the force of gravity and typically require power categories for the asynchronous machine above 30 MVA, the application of an asynchronous machine of the above-described type with the type according to the invention of the fastening of the winding elements in the rotor body is particularly important. With such machines, which are often driven with very strong fluctuating rotational speeds, It should be noted that the mechanical load and the thermal load represent a considerable challenge. Said challenge can be taken up due to the described type of the electrically conducting releasable fastening so that any damage of the asynchronous machine by spark erosion in the region of the insulation of the winding elements in the rotor can be prevented securely and reliably. The structure is hence simple and efficient and enables in particular a comparatively simple replacement of a possibly damaged winding element, without damaging here the rotor when replacing the winding element. This is first and foremost of vital importance with asynchronous machine in the field of hydroelectric power plants, since they are used quite intensively and over a very long time span. Moreover, the connecting means must protect the comparatively large and heavy winding elements against the force of gravity with the typical structure of the machine assembly with perpendicular rotation axis. This is quite possible with the connecting means according to the invention.

Additional advantageous embodiments of the asynchronous machine according to the invention as well as of the machine assembly with such an asynchronous machine result from the depending-claims related to the asynchronous machine and are distinct in the light of the embodiment example which is described more in detail below with reference to the figures.

Wherein

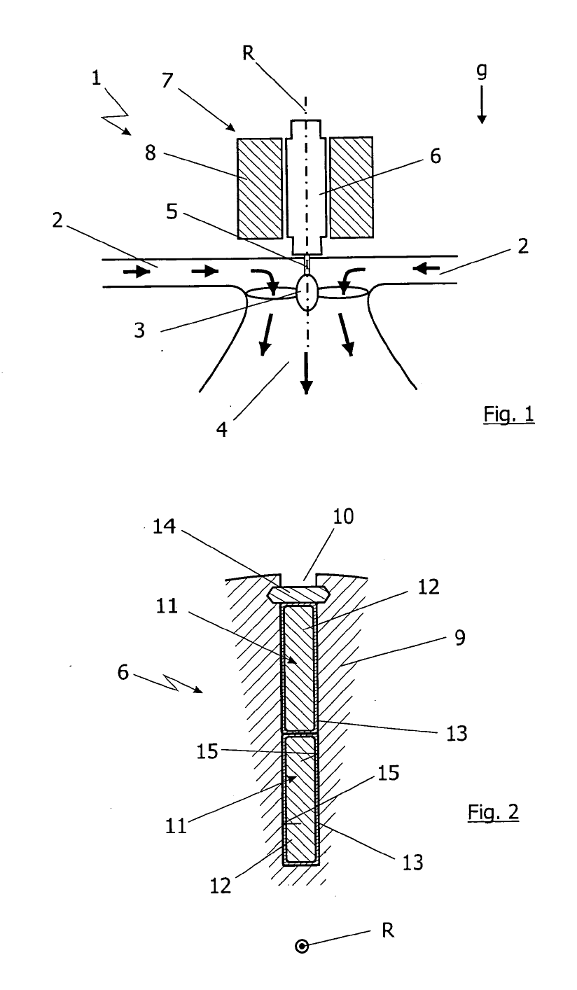

FIG. 1 shows a schematic diagram of a machine assembly for a hydro-electric power plant;

FIG. 2 shows a cut-out of a rotor of an asynchronous machine in a in a cut plane vertical to the rotation axis;

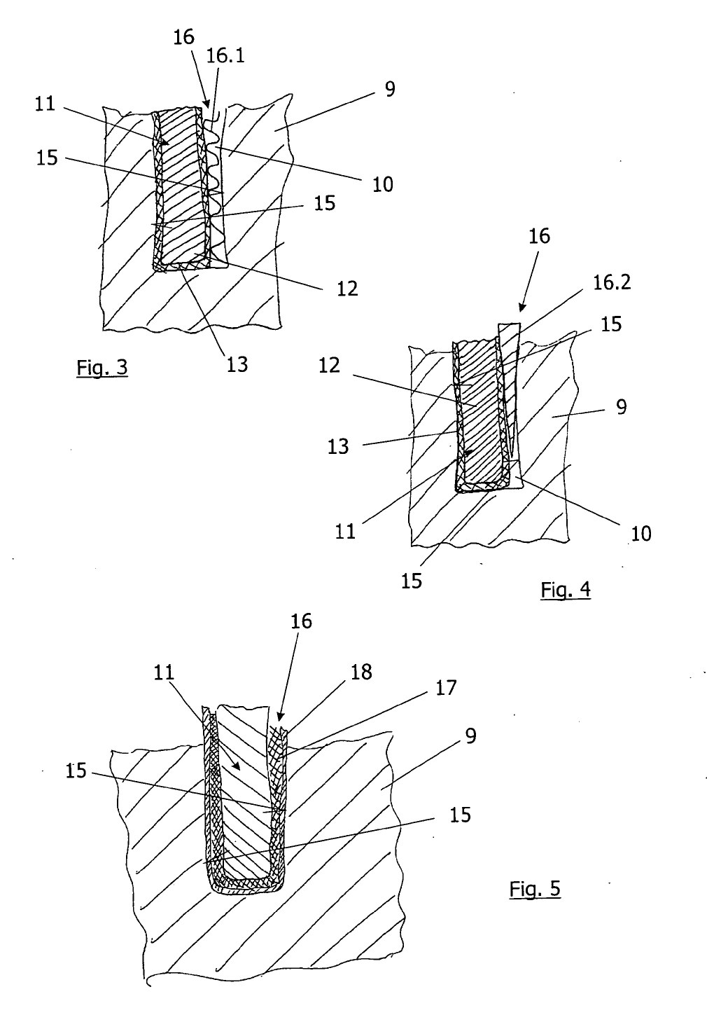

FIG. 3 shows an enlarged cut-out of the representation in FIG. 2 in a first embodiment according to the invention;

FIG. 4 shows an enlarged cut-out of the representation in FIG. 2 in a second embodiment according to the invention;

FIG. 5 shows an enlarged cut-out of the representation in FIG. 2 in a third embodiment according to the invention;

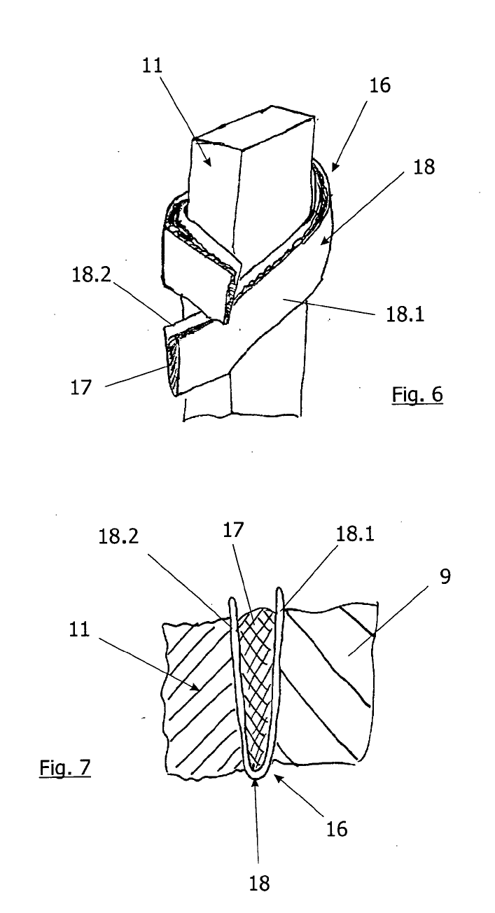

FIG. 6 shows a three-dimensional view of a fourth embodiment of the connection element according to the invention; and

FIG. 7 shows a sectional view of an enlargement of a cut-out according to FIG. 6.

A hydroelectric power plant 1 can be seen quite schematically in the representation of FIG. 1. From a hydraulic technical viewpoint, the core of the hydroelectric power plant 1 lies in a piping system 2, which guides water from the area of an upstream water not represented here to a water turbine 3 and discharges it through a diffuser 4 implicitly indicated into the area of a downstream water also non represented. The water turbine 3, which is driven by the water flowing from the upstream water to the downstream water, hence rotates around a rotation axis R, which is often usually erected in such plants perpendicular in direction of the force of gravity g. The rotation of the water turbine 3 is transferred via a shaft 5 to a rotor 6 of a double-fed asynchronous machine 7 with a slip-ring rotor. The asynchronous machine 7 moreover comprises a stator 8 implicitly indicated in addition to the rotor 6. The asynchronous machine 7 is used in the exemplary embodiment illustrated here to convert the rotational energy generated by the water on the water turbine 3 into electric energy. It also represents a generator in the embodiment example illustrated here. In complement thereto or alternately, it would obviously be also possible to use a pump turbine instead of the water turbine 3 illustrated here. Said pump turbine, common for example with pumped-storage power plants, can on the one hand convert water, flowing from the upstream water into the area of the downstream water, into rotational energy as described above. This enables to generate electric energy by means of the asynchronous machine 7. At moments in which there is an electrical energy surplus, the asynchronous machine 7 can also be driven by a motor, so as to pump back water from the area of the down-stream water back into the area of the upstream water via the pump turbine. This can then, if there is a greater requirement of electrical energy, be used again for recovering electrical energy as described above.

In the representation of FIG. 2, a cut-out of a portion of the rotor 6 is illustrated. The cross-section a plane vertical to the rotation axis R, which can be seen in FIG. 2 in a position explicitly not to scale, shows a rotor body 9 of the rotor 6, which typically consists of several sheet metal elements piled on top of one another in the axial direction. Said rotor body 9 shows a groove 10, which runs in the axial direction of the rotation axis R through the rotor body 10 and is open outwardly in radial direction. Two winding elements 11 are typically inserted into this groove 10. Said winding elements 11, which are also designated as rods, consist of a very good electrically conductive material 12, such as for instance copper. They can be realised as a full material or in the form of individual material strands connected to one another. The structure of the winding elements 11 moreover comprises an electrical insulation in addition to the very good electrically conductive material 12, which in a manner known per se, may by way of example consist of mica tapes soaked with epoxy resin and wound around the very good electrically conductive material 12. As a matter of course, in the described order of magnitude of the asynchronous machine 7, which includes a diameter of the rotor 6 of approx. 3 to 8 m for a typical use in hydroelectric power plants 1 and has a power of more than 30 MVA, the insulation 13 is a high voltage insulation. With such a high voltage insulation, there is typically a well-known outer corona protection the outside of the insulation 13. This is here an electrically conducting coating or an electrically conducting coating structure in the outside of the insulation 13, which ensures a connection hereof with the grounded rotor body 9.

The winding elements or rods 11 are subjected during operation of the asynchronous machine 7, due to the rotation of the rotor 6, to corresponding centrifugal forces, which can dislodge said elements or rods out of the groove 10 in radial direction. This is prevented in the structure illustrated here by a barrier element 14 which co-operates in a form fit manner with the material of the rotor body 9 in such a way that said material seals the groove 10 in radial direction outwardly and holds the winding elements 11 securely and reliably in radial direction in the groove 10.

There is now a gap space between the outer corona protection of the insulation 13 and a neighbouring wall 15 of the groove 10, which may hence cause flashover of sparks. An erosion may then crop up in the area of the insulation 13, which eventually destroys it and hence causes functional damages in the area of the asynchronous machine 7. This should be avoided at all costs. Besides, the fastening of the winding elements 11 should be mechanically releasable so that the winding elements 11 can be removed from the groove 10 by removing the barrier element 14.

A first connecting means 16 suitable for that purpose, in the form of a wave spring 16.1 acting as a spring element, can be seen in the representation of FIG. 3. The wave spring is arranged between the insulation 13 having said outer corona protection and the wall 15 of the groove 10, in the cut-out illustrated here of the radially arranged winding elements 11. The wave spring 16 presses the electrical insulation 13 having said outer corona protection adequately situated on the side of the rod 11 facing away from the wave spring 16.1 against the wall 15 of the groove 10 on the one hand and ensures a mechanical connection and an electrical bonding via the electrically conductive wave springs 16.1 between the electrical insulation 13 and the other wall 15 of the groove 10 along the periphery. This enables to obtain a secure and reliable fastening which even in the presence of fluctuations and otherwise mechanical movements in the area of the rod 11 as well as movements due to different thermal elongation of the rod 11 and of the rotor body 9 ensures a reliable connection and a reliable electrically conductive contact between the rotor body 9 and the electrical insulation 13 of the rod 11.

An alternative embodiment of the connecting means 16 can be seen in the representation of FIG. 4. In other respects, the structure corresponds to that described in FIG. 3. The connecting means 16 is designed as a wedge 16.2 instead of the wave spring 16.1. This wedge 16.2 also, for wedging the rod 11 in the groove 10 accordingly, presses the side of the rod 11 facing away from the wedge against a wall 15 of the groove 10 and provides bonding as well as presses the other side of the rod 11 beyond the wedge 16.2 up to the other wall 15 of the groove 10.

An alternative embodiment of the connecting means 16 is represented on FIG. 5, which shows substantially the same cut-out as the illustration in FIGS. 3 and 4. The rod 11 is represented as a principle cross section and shows the material 12 and the electrical insulation 13 in a single structure, whereas they are the same in the cross section. This enables to simplify the representation in FIG. 5 as well as in the following FIGS. 6 and 7. The rod 11 is surrounded by a pasty substance 17 in the representation of FIG. 5 with its insulation 13, which is not explicitly recognisable here, a pasty substance surrounded by a layer 18 for its own part. Said layer 18 can for instance be designed as a film, in particular however as an electrically conductive paper. The pasty substance 17 can be designed as a putty, which exhibits a certain electrical conductivity through suitable addition of electrically conductive particles, for example metallic particles, graphite or similar. Globally, this structure composed of the pasty substance 17 and the layer 18, which forms the connection means 16, surrounds the rod 11 with its insulation having said outer corona protection, not represented explicitly. The pasty substance 17 is hence designed in such a way that increases its volume slightly when hardening, i.e. wells up. Such a substance can for example be realised on the basis of silicons. During the assembly, the rod 11 together with its insulation and the outer corona protection is coated with the pasty substance 17 and wrapped with the layer 18 made of conductive paper. The structure is then inserted into the groove 10. The pasty substance 17 will then harden and well up. The consequence is a tension of the rod 11 in the groove 10 bracing in a positively locking manner so that said rod is maintained securely and reliably and that an electrical bonding of the outer corona protection of the rod 11 is established with the wall 15 of the groove 10 and hence with the rotor body 9 via the electrically conducting layer 18 and the electrically conducting pasty substance 17. Simultaneously, the layer 18 prevents the pasty substance 17 from adhering to the walls 15 of the groove 10 in the area of the rotor body 9. Consequently, the structure can be removed in radial direction outwardly from the region of the rotor 6 after releasing the barrier element 14 represented in FIG. 2, without damaging the rotor body 9 itself through this operation.

An alternative for that purpose can be seen in the representation of FIG. 6. It is a three-dimensional representation of the use of the layer 18 which is divided by folding into at least two sections 18.1 and 18.2 connected to one another. The pasty substance 17 is inserted between both said sections 18.1 and 18.2. Said compound of the folded conductive layer 18 and pasty substance 17, which together form the connecting means 16, wraps the rod 11 provided with the insulation and the outer corona protection between both said sections 18.1 and 18.2 formed by the folding. The rod wrapped this way is pushed into the groove 10 and the pasty substance 17 wells up when hardening as described above. Secure and reliable fastening of the rod 11 in the groove 10 can be achieved in a positive-locking manner.

The enlarged sectional view of FIG. 7 shows a portion of the wall 15 of the groove 10 as well as a portion of the rod 11 provided with the insulation 13 and the outer corona protection, whereas the insulation and the outer corona protection are not represented explicitly. The folded layer 18 with both sections 18.1 and 18.2, with the pasty substance 17 therebetween, lies between the rod 11 and the rotor body 9. The advantage with respect to the above-described structure lies in that the pasty substance 17 needs not be electrically conductive and for example can be a simple silicon or the like. The electrical conductivity between the surface of the outer corona protection of the rod 11 and the wall 15 of the groove 10 in the rotor body 9 is realised by the electrically conducting layer 18, which with its one section 18.2 contacts the outer corona protection of the rod 11 and with its other section 18.1 the wall 15 of the groove 10. Moreover, the layer 18 prevents the connecting means 16 from sticking in the region of the wall 15 of the groove 10 as well as in the region of the rod 11 so as to ensure releasability of the connecting means 16 with respect to the rod 11 as well as with respect to the wall 15 of the groove 10.

1-14. (canceled)

15. Asynchronous machine having a slip-ring rotor for use with a variable rotational speed, with: a rotor, a rotor body, having grooves mounted radially into the rotor body, winding elements of the rotor, from which respectively at least one element runs axially through each of the grooves, locking elements, which cooperate in a form fit manner with the rotor body and close the grooves radially and outwardly, a high voltage insulation with an outer corona protection around each of the winding elements, wherein electrically conducting connection means for releasable connection of the winding element with the rotor body are arranged between the outer corona protection of the winding element and at least one neighboring wall of the groove along the around periphery, whereas the connecting means include an electrically conducting layer and a hardening pasty substance, whereas the pasty substance is not electrically conductive; and the layer is designed with at least one fold, whereas the pasty substance is arranged between at least two sections formed by the fold.

16. An asynchronous machine according to claim 15, wherein the pasty substance increases its volume when hardening.

17. An asynchronous machine according to claim 15, wherein the layer is arranged between the pasty substance and the wall of the groove.

18. An asynchronous machine according to claim 15, wherein the pasty substance hardens elastically.

19. An asynchronous machine according to claim 15, wherein the sections are arranged between the pasty substance and the wall of the groove on the one hand and the pasty substance and the outer corona protection of the winding elements on the other hand.

20. An asynchronous machine according to claim 15, wherein the connecting means include wedges made of electrically conducting material.

21. An asynchronous machine according to claim 15, wherein the connecting means include spring elements made of electrically conducting material.

22. An asynchronous machine according to claim 21, wherein the spring elements are formed as wave springs.

23. An asynchronous machine according to claim 15, characterized by a double-fed layout.

24. An asynchronous machine according to claim 15, characterized by a nominal load of more than 30 MVA.

25. A machine assembly for a hydroelectric power plant having a water turbine or a pump turbine and the asynchronous machine according to claim 15, which is driven by the water turbine or the pump turbine or drives the pump turbine.

26. An asynchronous machine according to claim 16, wherein the layer is arranged between the pasty substance and the wall of the groove.

27. An asynchronous machine according to claim 16, wherein the pasty substance hardens elastically.

28. An asynchronous machine according to claim 17, wherein the pasty substance hardens elastically.

29. An asynchronous machine according to claim 16, wherein the connecting means include wedges made of electrically conducting material.

30. An asynchronous machine according to claim 17, wherein the connecting means include wedges made of electrically conducting material.

31. An asynchronous machine according to claim 18, wherein the connecting means include wedges made of electrically conducting material.

32. An asynchronous machine according to claim 19, wherein the connecting means include wedges made of electrically conducting material.

33. An asynchronous machine according to claim 16, wherein the connecting means include spring elements made of electrically conducting material.

34. An asynchronous machine according to claim 17, wherein the connecting means include spring elements made of electrically conducting material.
